(19) United States
(12) Patent Application Publication
(10) Pub. No.: US 2019/0255913 A1
(43) Pub. Date: Aug. 22, 2019

(54) SYSTEM AND METHOD FOR HEATING A CABIN OF A MOTOR VEHICLE

(71) Applicant: FORD GLOBAL TECHNOLOGIES, LLC, Dearborn, MI (US)

(72) Inventors: Joseph Norman Ulrey, St. Joseph, MI (US); Gopichandra Surnilla, West Bloomfield, MI (US); Ross Dykstra Pursifull, Dearborn, MI (US); Thomas George Leone, Ypsilanti, MI (US)

(21) Appl. No.: 15/899,110

(22) Filed: Feb. 19, 2018

(51) Int. Cl. B60H 1/20; F01N 5/02; B60H 1/00

(52) U.S. Cl. CPC B60H 1/20; B60H 1/00821; F01N 5/02

(57) ABSTRACT

A cabin heating system includes an exhaust heat exchanger having a cabin air conduit. That cabin air conduit includes a check valve, a pressure relief valve and a heat exchange section between the check valve and the pressure relief valve. The cabin heating system also includes a control module configured to maintain cabin air in the cabin air conduit at a first pressure P₁ while exhaust gas in an exhaust bypass has a second pressure P₂ where P₁>P₂.

### TECHNICAL FIELD

This document relates generally to the motor vehicle equipment field and, more particularly, to a system and method for heating the cabin of a motor vehicle by utilizing the heat of the motor vehicle's internal combustion engine exhaust.

### BACKGROUND

Engine coolant based cabin heating fails to provide instant cabin heat when the motor vehicle has been sitting for substantial periods of time in cold weather conditions. This document relates to a new and improved cabin heating system and method that provides near instantaneous cabin heating by recovering heat from the exhaust gases of the internal combustion engine of the motor vehicle. Advantageously, this is done in a safe and very efficient manner. As such, the present cabin heating system and method represent a significant advance in the art.

### SUMMARY

In accordance with the purposes and benefits described herein, a new and improved cabin heating system is provided. That cabin heating system comprises an exhaust heat exchanger including a cabin air conduit having a check valve, a pressure relief valve and a heat exchange section between the check valve and the pressure relief valve.

The exhaust heat exchanger may further include an exhaust bypass having a first end and a second end connected to an exhaust conduit. Further, the cabin heating system may include a control module. That control module may be configured to maintain cabin air in the cabin air conduit between the check valve and the pressure relief valve at a first pressure P₁ while exhaust gas in the exhaust bypass has a second pressure P₂ where P₁>P₂. This pressure gradient ensures that exhaust gases do not enter the motor vehicle cabin even if a leak develops in the exhaust heat exchanger.

The heat exchange section may extend through the exhaust bypass. Further, the control module may include a controller and a pressure monitoring device connected to the cabin air conduit between the check valve and the pressure relief valve downstream from the check valve. In at least some of the many possible embodiments, that pressure monitoring device is connected to the cabin air conduit between the heat exchange section and the pressure relief valve.

The control module of the cabin heating system may further include a pump (e.g. turbine, fan) to circulate cabin air through the cabin air conduit. The pump may be provided upstream from the check valve.

Still further, the cabin heating system may further include a throttle valve to control the flow of exhaust gases. That throttle valve may be provided in the exhaust conduit between the first end and the second end of the exhaust bypass where the valve functions to control the flow of exhaust gas through the exhaust bypass. In at least some of the many possible embodiments, that exhaust bypass is downstream from a catalytic converter of the motor vehicle. At low exhaust flow rates, most exhaust is routed through the exhaust bypass and at high exhaust rates, the back pressure is limited by opening the throttle valve.

In accordance with an additional aspect, a method is provided of heating a passenger cabin in a motor vehicle. That method comprises the steps of: a) circulating cabin air through a cabin air conduit (including a check valve, a pressure relief valve downstream from the check valve and a heat exchange section between the check valve and the pressure relief valve), b) heating the cabin air passing through the heat exchange section with exhaust gas passing through an exhaust bypass and c) maintaining, by a control module, the cabin air in the heat exchange section between the check valve and the pressure relief valve at a first pressure P₁ while the exhaust gas in the exhaust bypass has a second pressure P₂ where P₁>P₂.

The method may further include the step of monitoring, by a pressure monitoring device of the control module, the first pressure P₁. In addition, the method may include the step of controlling, by a throttle valve, the flow of the exhaust gases through the exhaust bypass.

The step of maintaining the cabin air in the cabin air conduit between the check valve and the pressure relief valve at a first pressure P₁ may include the step of adjusting output of a pump that circulates the cabin air through the cabin air conduit. That pump may be located upstream from the check valve. If the pump is off, the check valve and the pressure relief valve keep the heat exchange section pressurized thus preventing the lower pressure exhaust gasses from entering the heat exchange section. But even if it were not pressurized and the pump were off, the check valve and the pressure relief valve would isolate the heat exchange section from the cabin. But it needs to be pressurized to satisfy the pressure monitoring device.

In the following description, there are shown and described several preferred embodiments of the cabin heating system and the related method of heating a motor vehicle cabin. As it should be realized, the cabin heating system and method are capable of other, different embodiments and their several details are capable of modification in various, obvious aspects all without departing from the cabin heating system and method as set forth and described in the following claims. Accordingly, the drawings and descriptions should be regarded as illustrative in nature and not as restrictive.

### BRIEF DESCRIPTION OF THE DRAWING FIGURE

The accompanying drawing FIGURE incorporated herein and forming a part of the specification, illustrates several aspects of the cabin heating system and method of heating a motor vehicle cabin and together with the description serve to explain certain principles thereof.

FIG. 1 is a schematic representation of the cabin heating system that recovers heat from the exhaust gases of the motor vehicle and utilizes that heat to heat the cabin air in order to maintain the comfort of the passengers within the cabin.

Reference will now be made in detail to the present preferred embodiments of the cabin heating system and method, examples of which are illustrated in the accompanying drawing FIGURES.

### DETAILED DESCRIPTION

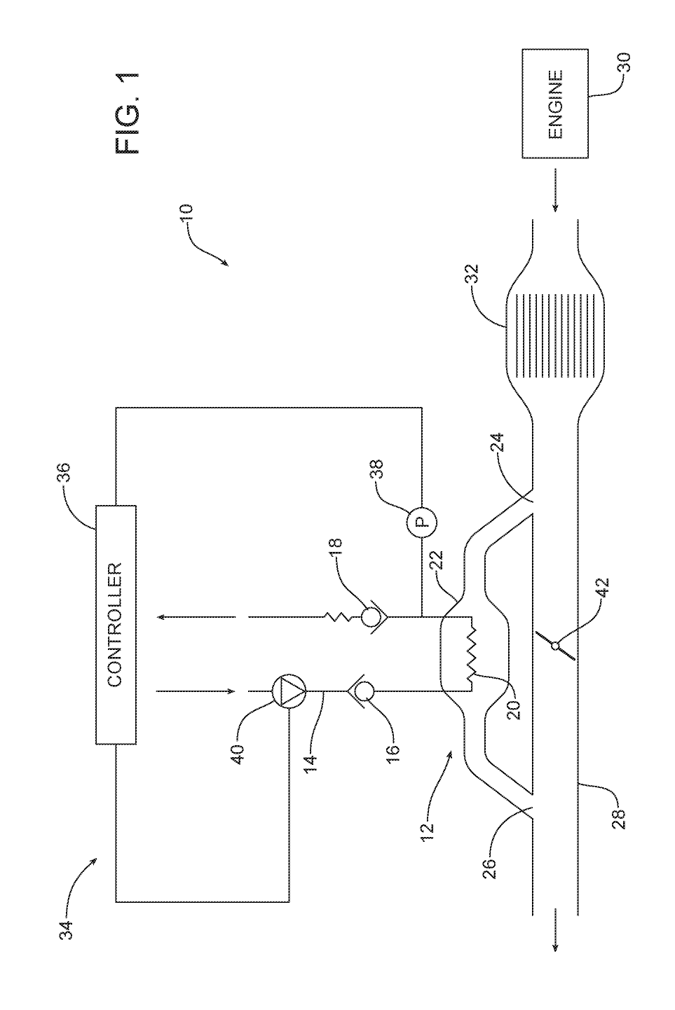

Reference is now made to FIG. 1 illustrating the new and improved cabin heating system 10. That cabin heating system 10 includes an exhaust heat exchanger 12 having a cabin air conduit 14 including a check valve 16, a pressure relief valve 18 and a heat exchange section 20 extending between the check valve and the pressure relief valve.

The exhaust heat exchanger 12 of the cabin heating system 10 further includes an exhaust bypass 22. The exhausts bypass 22 has a first end 24 and a second end 26 connected to the exhaust conduit 28. The exhaust conduit 28 is the principle passageway for discharge of the exhaust gases generated by the internal combustion engine 30 of the motor vehicle downstream from the catalytic converter 32.

The cabin heating system 10 also includes a control module 34. That control module 34 may be adapted to maintain cabin air in the heat exchange section 20 of the cabin air conduit 14 between the check valve 16 and the pressure relief valve 18 at a first pressure P₁ while exhaust gas in the exhaust bypass 20 has a second pressure P₂ where P₁>P₂. Here it should be noted that the heat exchange section 20 extends through the exhaust bypass 22 thereby effectively placing the cabin air within the heat exchange section in heat exchange relationship with the exhaust gases in the exhaust bypass. Thus, the wall of the heat exchange section 20 may be constructed from a material impermeable to cabin air and exhaust gases and having a high temperature coefficient for efficient heat exchange.

As illustrated in FIG. 1, the control module 34 includes a controller 36 and a pressure monitoring device 38. The controller 36 may comprise a computing device such as a dedicated microprocessor or an electronic control unit (ECU) operating in accordance with instructions from appropriate control software. Thus, the controller 36 may comprise one or more processors, one or more memories, and one or more network interfaces all in communication with each other over one or more communication buses.

The pressure monitoring device 38 is connected to the cabin air conduit 14 between the check valve 16 and the pressure relief valve 18 downstream from the check valve. More specifically, in the illustrated embodiment, the pressure monitoring device 38 is connected to the cabin air conduit 14 between the heat exchange section 20 and the pressure relief valve 18.

The control module 34 may also include a pump 40 to circulate the cabin air through the cabin air conduit 14. As illustrated in FIG. 1, the pump 40 is provided upstream from the check valve 16. The controller 36 controls the operation of the pump 40 in order to control the first pressure P₁ of the cabin air in the downstream heat exchange section 20 of the cabin air conduit 14.

The cabin heating system 10 also includes a throttle valve 42 in the exhaust conduit 28 between the first end 24 and the second end 26 of the exhaust bypass 22. The throttle valve 42 functions to control the flow of exhaust gas through the exhaust bypass 22 in heat exchange relationship with the heat exchange section 20 of the cabin air conduit 14.

The cabin heating system 10 functions in a method of heating a passenger cabin in a motor vehicle. That method includes circulating cabin air through the cabin air conduit 14 past the check valve 16 and through the heat exchange section 20 past the pressure relief valve 18. The method also includes the step of heating the cabin air passing through the heat exchange section 20 with heat recovered from the exhaust gas passing through the exhaust bypass 22. In addition, the method includes the step of maintaining, by the control module 32, the cabin air in the heat exchange section 20 between the check valve 16 and the pressure relief valve 18 at a first pressure P₁ while the exhaust gas in the exhaust bypass 22 has a second pressure P₂ where P₁>P₂. Here it should be noted that the continuous wall of the heat exchange section 20 functions to transfer heat from the exhaust gas in the exhaust bypass 22 to the cabin air in the heat exchange section 20 while preventing the mixing of the exhaust gas and cabin air. However in the event a leak should ever occur, the cabin air in the heat exchange section 20 is always maintained at a higher pressure than the exhaust gas in the exhaust bypass 22 thereby ensuring that any leak is toward the exhaust bypass 22: that is, cabin air may leak toward the exhaust bypass 22 but exhaust gas may not leak toward the heat exchange section 20.

Toward this end the method may include monitoring, by the pressure monitoring device 38 of the control module 34 the first pressure P₁ of the cabin air. Further, the method may include the step of adjusting of the output of the pump 40 that circulates the cabin air through the cabin air conduit 14 and, more particularly, the heat exchange section 20 to ensure that the first pressure P₁ is always greater than the second pressure of the exhaust gas P₂. In addition, the method may include the step of controlling, by the throttle valve 42, the flow of exhaust gases through the exhaust bypass 22 for heat exchange with the cabin air in the heat exchange section 20.

In summary, the cabin heating system 10 and related method of heating a passenger cabin in a motor vehicle described herein provide a number of benefits and advantages. The cabin heating system 10 and method allow for substantially instantaneous heating of the cabin air in the motor vehicle upon starting of the internal combustion engine 30 of the motor vehicle. This rapid heating provides warming comfort to passengers in the cabin of the motor vehicle far more quickly than is possible with traditional heating systems that rely upon heat recovered from the engine coolant. Advantageously, these beneficial results are achieved in a highly efficient and safe manner. A pressure gradient is maintained at all times between the pressure within the heat exchange section 20 of the cabin air conduit 14 and the pressure of the exhaust gas within the exhaust bypass 22. In other words, the control module 34 functions to ensure that the cabin air is maintained in the heat exchange section 20 at a first pressure P₁ that is greater than the second pressure P₂ of the exhaust gases within the exhaust bypass 22.

The foregoing has been presented for purposes of illustration and description. It is not intended to be exhaustive or to limit the embodiments to the precise form disclosed. Obvious modifications and variations are possible in light of the above teachings. For example, in the illustrated embodiment the controller 36 is configured to maintain the pressure of the cabin air in the heat exchange section 20 above any foreseeable pressure of the exhaust gases in the exhaust bypass 22. In other embodiments, a second pressure monitor may be provided to monitor the pressure of the exhaust gases within the exhaust bypass 22 and the controller 36 could be configured to (a) continuously compare the pressure of the cabin air in the heat exchange section 14 and the exhaust gases in the exhaust bypass and (b) continuously maintain the cabin air pressure at a greater level. All such modifications and variations are within the scope of the appended claims when interpreted in accordance with the breadth to which they are fairly, legally and equitably entitled.

What is claimed:

1. A cabin heating system, comprising:
an exhaust heat exchanger including a cabin air conduit including a check valve, a pressure relief valve and a heat exchange section between said check valve and said pressure relief valve.

2. The cabin heating system of claim 1, wherein said exhaust heat exchanger further includes an exhaust bypass having a first end and a second end connected to an exhaust conduit.

3. The cabin heating system of claim 2, further including a control module configured to maintain cabin air in said cabin air conduit between said check valve and said pressure relief valve at a first pressure P₁ while exhaust gas in said exhaust bypass has a second pressure P₂ where P₁>P₂.

4. The cabin heating system of claim 3, wherein said heat exchange section extends through said exhaust bypass.

5. The cabin heating system of claim 4, wherein said control module includes a controller and a pressure monitoring device connected to said cabin air conduit between said check valve and said pressure relief valve downstream of said check valve.

6. The cabin heating system of claim 5, wherein said pressure monitoring device is connected to said cabin air conduit between said heat exchange section and said pressure relief valve.

7. The cabin heating system of claim 6, wherein said control module includes a pump to circulate cabin air through said cabin air conduit.

8. The cabin heating system of claim 7, wherein said pump is upstream from said check valve.

9. The cabin heating system of claim 8, further including a throttle valve in said exhaust conduit between said first end and said second end of said exhaust bypass to control flow of exhaust gas through said exhaust bypass.

10. The cabin heating system of claim 9, wherein said exhaust bypass is downstream from a catalytic converter.

11. A method of heating a passenger cabin in a motor vehicle, comprising:
circulating cabin air through a cabin air conduit including a check valve, a pressure relief valve, downstream from said check valve, and a heat exchange section between said check valve and said pressure relief valve;
heating said cabin air passing through said heat exchange section with exhaust gas passing through an exhaust bypass; and
maintaining, by a control module, said cabin air in said heat exchange section between said check valve and said pressure relief valve at a first pressure P₁ while said exhaust gas in said exhaust bypass has a second pressure P₂ where P₁>P₂.

12. The method of claim 11, including monitoring, by a pressure monitoring device of said control module, said first pressure P₁.

13. The method of claim 12, wherein said maintaining includes adjusting output of a pump that circulates said cabin air through said cabin air conduit wherein said pump is located upstream from said check valve.

14. The method of claim 13, further including controlling, by a throttle valve, flow of said exhaust gas through said exhaust bypass.
